(19) United States
(12) Patent Application Publication
(10) Pub. No.: US 2009/0172588 A1
(43) Pub. Date: Jul. 2, 2009

(54) SYSTEM AND METHOD FOR CONTROLLING DRAGGING SCROLL BARS IN A WEB TABLE

(75) Inventors: CHUNG-I LEE, Tu-Cheng (TW); YI-GUO WANG, Shenzhen (CN); JIAN HUANG, Shenzhen City (CN); DE-JIA LU, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/344,221

(22) Filed: Dec. 25, 2008

(30) Foreign Application Priority Data
Dec. 27, 2007 (CN) 200710203457.2

(51) Int. Cl. G06F 3/048

(52) U.S. Cl. 715/786

(57) ABSTRACT

A computer-based method for controlling dragging scroll bars in a web table includes dividing the web table into a title area and a data area, and generating scroll bars for the data area. The method further includes obtaining a position and a status of a cursor on a display, and determining a moving direction of the cursor if the cursor is positioned to drag the scroll bars according to the position and the status of the cursor. Furthermore, the method includes computing a distance that the cursor moves along the moving direction on the display, and moving the title area the distance along the moving direction.

### BACKGROUND OF THE INVENTION

1. Field of the Invention

Embodiments of the present disclosure relate to information management systems and methods, and more particularly to a system and method for controlling dragging scroll bars in a web table.

2. Description of Related Art

As “web” technology has evolved, a web system is accessed via a web browser over a network such as the Internet or an intranet. In an enterprise, the web system is an important platform for employees to acquire inner information of the enterprise. For example, the employees can login to a sales system to query the sales data on a client device via a web browser. Usually, the data in the web system can be presented in a web table to users. A web table includes a title area and a data area. The web table often contains scroll bars for moving the data area. However, the title area may not simultaneously move along with the data area when a user moves the data area by the scroll bars.

Therefore, what is needed is a system and method overcoming the aforementioned problem.

### BRIEF DESCRIPTION OF THE DRAWINGS

FIG. 1 is a block diagram of one embodiment of a system for controlling dragging scroll bars in a web table.

FIG. 2 is a block diagram of one embodiment of a computer in FIG. 1.

FIG. 3 is a flowchart of one embodiment of a method for controlling dragging scroll bars in a web table.

FIG. 4 illustrates one embodiment of a web table.

### DETAILED DESCRIPTION OF CERTAIN INVENTIVE EMBODIMENTS

All of the processes described below may be embodied in, and fully automated via, function code modules executed by one or more general purpose computers or processors. The code modules may be stored in any type of computer-readable medium or other computer storage device. Some or all of the methods may alternatively be embodied in specialized computer hardware.

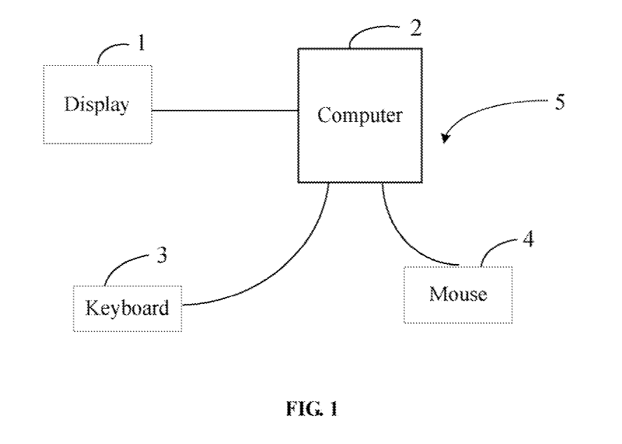

FIG. 1 is a block diagram of one embodiment of a system 5 for controlling dragging scroll bars in a web table. The system 5 may comprise a computer 2 comprising a plurality of peripherals and devices electronically connected to the computer 2. In one embodiment, the computer 2 may be electronically connected to a display 1, a keyboard 3, and a mouse 4 in order to input/output various computer signals or interfaces to a user. The computer 2 includes a memory system, such as random access memory (RAM). In one embodiment, the computer 2 may be a personal computer (PC), a network server, and can also be any other appropriate data-processing equipment.

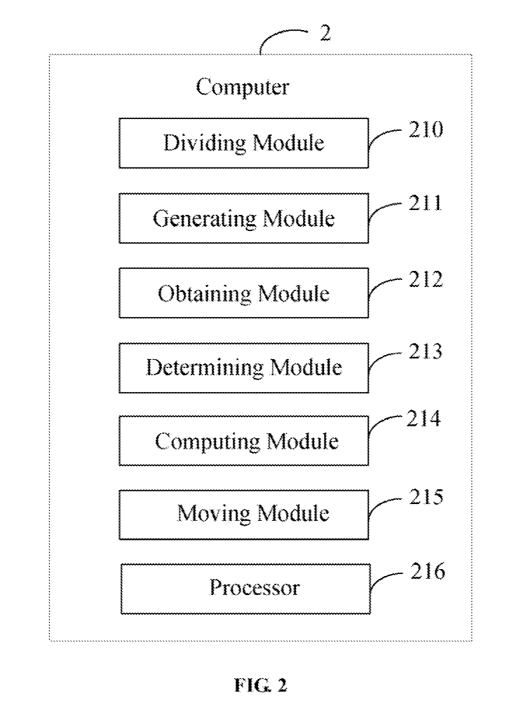

FIG. 2 is a block diagram of one embodiment of the computer 2 in FIG. 1. In the illustrated embodiment, the computer 2 includes a dividing module 210, a generating module 211, an obtaining module 212, a determining module 213, a computing module 214, and a moving module 215. The modules 210, 211, 212, 213, 214, 215 may be used to execute one or more operations for the computer 2. Additionally, the computer 2 may comprise one or more specialized or general purpose processors, such as a processor 216 for executing the modules 210, 211, 212, 213, 214, 215.

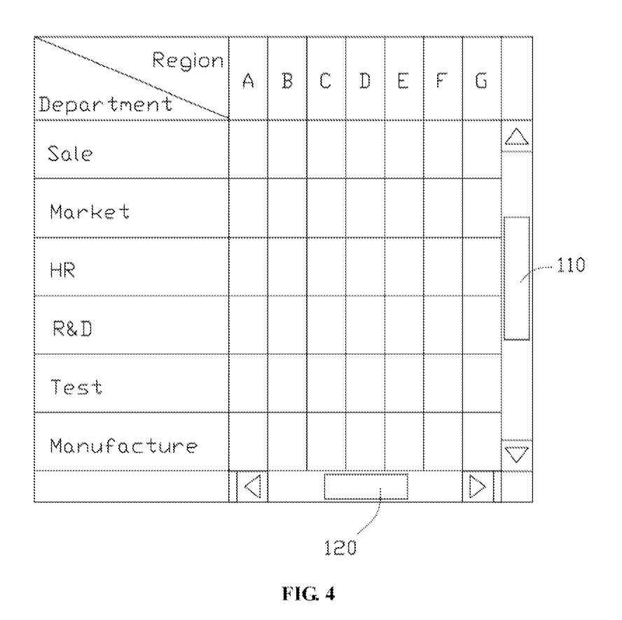

The dividing module 210 is configured for dividing a web table into a title area and a data area. In one embodiment, the web table is divided by hypertext markup language (HTML), and is rendered in a web browser. As shown in FIG. 4, the illustrated web table has seven columns and nine rows. The title area in the web table is used to display the column names and the row names. For example, the first row includes the column names such as “a,” “b,” “c,” “d,” “e,” “f,” or “g,” the first column includes the row names such as “Sale,” “Market,” “HR,” “R&D,” “Test,” or “Manufacture.” The data area is used to display different kinds of data, such as sales data of products, etc. In one embodiment, the blank area is data area as shown in FIG. 4.

The generating module 211 is configured for generating scroll bars for the data area. In one embodiment, as shown FIG. 4, the scroll bars include a vertical scroll bar 110 and a horizontal scroll bar 120. The vertical scroll bar 110 moves the data area along a vertical direction. The horizontal scroll bar 120 moves the data area along a horizontal direction.

The obtaining module 212 is configured for obtaining a position and a status of a cursor on a display 1. Depending on the embodiment, the status of the cursor may be a left-click status, a right-click status, or a double-click status.

The determining module 213 is further configured for determining if the cursor is positioned to drag the scroll bars according to the position and the status of the cursor on the display 1. In one embodiment, if the cursor is positioned on the scroll bars, and the cursor is in the left-click status, the determining module 211 determines that the cursor is positioned to drag the scroll bars. For example, if the cursor is positioned on the vertical scroll bar 110, and the cursor is in the left-click status, the determining module 211 determines that the cursor is positioned to drag the vertical scroll bar 110 along the vertical direction.

The determining module 213 is further configured for determining a moving direction of the cursor along the display 1. In one embodiment, the moving direction of the cursor may be a horizontal direction or a vertical direction. For example, if the cursor drags the vertical scroll bar 110, then the moving direction of the cursor is the vertical direction.

The computing module 214 is configured for computing a distance that the cursor moves along the moving direction.

One embodiment of a method for computing a distance that the cursor moves along the horizontal direction is described as follows: (1) obtaining a length M and the number of pixels N distributed in a row of the display 1 along the horizontal direction. (2) obtaining the number of pixels S that the cursor passed through during moving along the horizontal direction. (3) computing the distance D along the horizontal direction according to the length M, the number of pixels N and the number of pixels S. (4) Using the formula:

$$D = \frac{M * S}{N} ,$$

for computing the distance that the cursor moves along the horizontal direction.

One embodiment of a method for computing a distance that the cursor moves along the vertical direction is described as follows: (1) obtaining a width M and the number of pixels N distributed in a column of the display 1 along the vertical direction. (2) obtaining the number of pixels S that the cursor passed through during moving along the vertical direction. (3) computing the distance D along the vertical direction according to the length M, the number of pixels N and the number of pixels S. (4) Using the formula:

$$D = \frac{M * S}{N} ,$$

for computing the distance that the cursor moves along the vertical direction.

The moving module 215 is configured for moving the title area the distance along the moving direction accordingly. In one embodiment, if the cursor has moved 3 centimeters along the horizontal direction, the moving module 215 simultaneously moves the first row of the web table 3 centimeters along the horizontal direction. In another embodiment, if the cursor has moved 3 centimeters along the vertical direction, the moving module 215 simultaneously moves the first column of the web table 3 centimeters along the vertical direction.

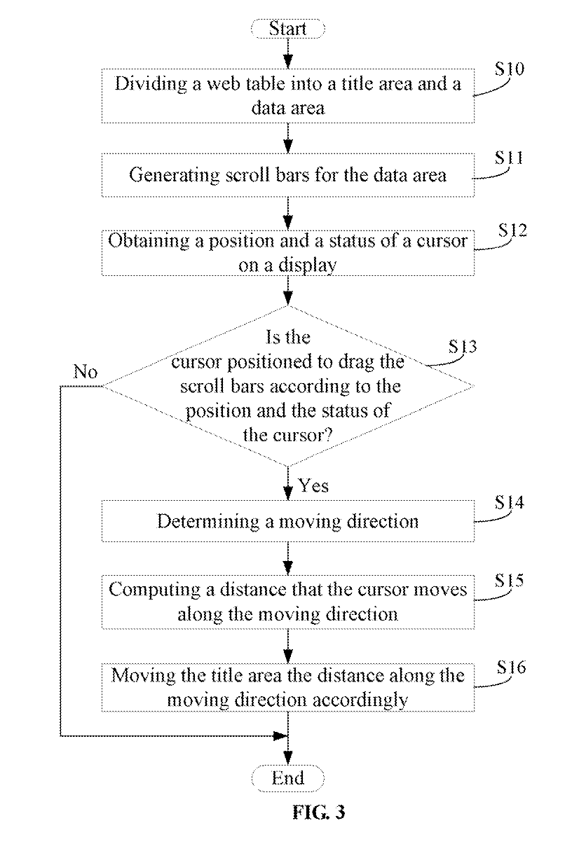

FIG. 3 is a flowchart of one embodiment of a method for controlling dragging scroll bars in a web table. Depending on the embodiment, additional blocks may be added, others deleted, and the ordering of the blocks may be changed.

In block S10, the dividing module 210 divides a web table into a title area and a data area. As mentioned above, the title area in the web table is used to display the column names and the row names and the data area is used to display different kinds of data, such as sales data of products, etc. In one embodiment, the blank area is data area as shown in FIG. 4.

In block S11, the generating module 211 generates scroll bars for the data area. As mentioned above, as shown FIG. 4, the scroll bars include a vertical scroll bar 110 and a horizontal scroll bar 120. The vertical scroll bar 110 moves the data area along a vertical direction. The horizontal scroll bar 120 moves the data area along a horizontal direction.

In block S12, the obtaining module 212 obtains a position and a status of a cursor on the display 1.

In block S13, the determining module 213 determines if the cursor is positioned to drag the scroll bars according to the position and the status of the cursor on the display 1. If the determining module 213 determines that the cursor is not positioned to drag the scroll bars according to the position and the status of the cursor, the procedure ends. Otherwise, if the determining module 213 determines that the cursor is positioned to drag the scroll bars according to the position and the status of the cursor, the procedure turn to block S14.

In block S14, the determining module 213 determines a moving direction of the cursor. As mentioned above, the moving direction of the cursor may be a horizontal direction or a vertical direction along the display 1. For example, if the cursor moves the vertical scroll bar 110, the moving direction of the cursor is the vertical direction.

In block S15, the computing module 211 computes a distance that the cursor moves along the moving direction. As mentioned above, the distance may be computed according to the formula D that the cursor moves along the horizontal and vertical direction.

In block S16, the moving module 215 moves the title area the distance along the moving direction accordingly. As mentioned above, for example, assuming that the cursor has moved 3 centimeters along the horizontal direction, the moving module 215 simultaneously moves the first row of the web table 3 centimeters along the horizontal direction. In another example, assuming that the cursor has moved 3 centimeters along the vertical direction, the moving module 215 simultaneously moves the first column of the web table 3 centimeters along the vertical direction.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for controlling dragging scroll bars in a web table, the system comprising:
a dividing module configured for dividing the web table into a title area and a data area;
a generating module configured for generating scroll bars for the data area;
an obtaining module configured for obtaining a position and a status of a cursor on a display;
a determining module configured for determining if the cursor is positioned to drag the scroll bars according to the position and the status of the cursor, and determining a moving direction of the cursor along the display;
a computing module configured for computing a distance that the cursor moves along the moving direction;
a moving module configured for moving the title area the distance along the moving direction; and
at least one processor that executes the dividing module, the generating module, the obtaining module, the determining module, the computing module, and the moving module.

2. The system of claim 1, wherein the scroll bars comprise a horizontal scroll bar and a vertical scroll bar.

3. The system of claim 1, wherein the status of the cursor comprises a left-click status, a right-click status, or a double-click status.

4. The system of claim 1, wherein the moving direction is a vertical direction or a horizontal direction along the display.

5. A computer-based method for controlling dragging scroll bars in a web table, the method comprising:
dividing the web table into a title area and a data area;
generating scroll bars for the data area;
obtaining a position and a status of a cursor on a display;
determining if the cursor is positioned to drag the scroll bars according to the position and the status of the cursor, and determining a moving direction of the cursor along the display;
computing a distance that the cursor moves along the moving direction; and
moving the title area the distance along the moving direction.

6. The method of claim 5, wherein the scroll bars comprise a horizontal scroll bar and a vertical scroll bar.

7. The method of claim 5, wherein the status of the cursor comprises a left-click status, a right-click status, or a double-click status.

8. The method of claim 5, wherein the moving direction comprises a horizontal direction or a vertical direction along the display.

9. The method of claim 8, wherein the block of computing a distance in the horizontal direction comprises:
(a) obtaining a length M and the number of pixels N distributed in a row of the display along the horizontal direction;
(b) obtaining the number of pixels S that the cursor passed through during moving along the horizontal direction; and
(c) computing the distance D along the horizontal direction according to the length M, the number of pixels N and the number of pixels S.

10. The method of claim 9, wherein the distance D in the horizontal direction is computed as follows:
$$D = \frac{M * S}{N} .$$

11. The method of claim 8, wherein the block of computing a distance in the vertical direction comprises:
(a) obtaining a width M and the number of pixels N distributed in a column of the display along the vertical direction;
(b) obtaining the number of pixels S that the cursor passed through during moving along the vertical direction; and
(c) computing the distance D along the vertical direction according to the length M, the number pixels N and the number of pixels S.

12. The method of claim 11, wherein the distance D in the vertical direction is computed as follows:
$$D = \frac{M * S}{N} .$$

13. A computer-readable medium having stored thereon instructions that, when executed by a computer, causing the computer to perform a method for controlling dragging scroll bars in a web table, the method comprising:
dividing the web table into a title area and a data area;
generating scroll bars for the data area;
obtaining a position and a status of a cursor on a display;
determining if the cursor is positioned to drag the scroll bars according to the position and the status of the cursor, and determining a moving direction of the cursor along the display;
computing a distance that the cursor moves along the moving direction; and
moving the title area the distance along the moving direction.

14. The medium of claim 13, wherein the scroll bars comprise a horizontal scroll bar and a vertical scroll bar.

15. The medium of claim 13, wherein the status of the cursor comprises a left-click status, a right-click status, or a double-click status.

16. The medium of claim 13, wherein the moving direction is a vertical direction or a horizontal direction along the display.

17. The medium of claim 16, wherein the block of computing a distance in the horizontal direction comprises:
(a) obtaining a length M and the number of pixels N distributed in a row of the display along the horizontal direction;
(b) obtaining the number of pixels S that the cursor passed through during moving along the horizontal direction; and
(c) computing the distance D along the horizontal direction according to the length M, the number of pixels N and the number of pixels S.

18. The medium of claim 17, wherein the distance D in the horizontal direction is computed as follows:
$$D = \frac{M * S}{N} .$$

19. The method of claim 16, wherein the block of computing a distance in the vertical direction comprises:
(a) obtaining a width M and the number of pixels N distributed in a column of the display along the vertical direction;
(b) obtaining the number of pixels S that the cursor passed through during moving along the vertical direction; and
(c) computing the distance D along the vertical direction according to the length M, the number pixels N and the number of pixels S.

20. The medium of claim 19, wherein the distance D in the vertical direction is computed as follows:
$$D = \frac{M * S}{N} .$$
